(19) United States
(12) Patent Application Publication
(10) Pub. No.: US 2019/0205474 A1
(43) Pub. Date: Jul. 4, 2019

(54) Mining Search Logs for Query Metadata on Online Social Networks

(71) Applicant: Facebook, Inc., Menlo Park, CA (US)

(72) Inventors: Manoj Mahipat Pawar, San Jose, CA (US); Shiwen Cheng, Newark, CA (US)

(21) Appl. No.: 15/858,285

(22) Filed: Dec. 29, 2017

(51) Int. Cl. G06F 17/30; G06F 17/27

(52) U.S. Cl. CPC G06F 17/30867; G06F 17/3005; G06F 2216/03; G06F 17/2705; G06F 17/278; G06F 17/30038

(57) ABSTRACT

In one embodiment, a method includes receiving, from a client system associated with a first user of an online social network, a search query; parsing the search query to identify one or more n-grams; retrieving, for each identified n-gram, metadata from a mining-search-log database, where the metadata includes at least top N entity identifiers corresponding to entities associated with the identified n-gram and their respective click-through rates, and top K co-occurring n-grams for the identified n-gram; identifying a plurality of content objects matching the search query; ranking the content objects based on whether the content objects contain one or more of the top N entity identifiers or one or more of the top K co-occurring n-grams; and sending, to the client system, instructions for presenting one or more search results corresponding to the identified content objects in an order based on the ranking of the corresponding content objects.

### TECHNICAL FIELD

This disclosure generally relates to online social networks and performing searches for objects within a social-networking environment.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

Social-graph analysis views social relationships in terms of network theory consisting of nodes and edges. Nodes represent the individual actors within the networks, and edges represent the relationships between the actors. The resulting graph-based structures are often very complex. There can be many types of nodes and many types of edges for connecting nodes. In its simplest form, a social graph is a map of all of the relevant edges between all the nodes being studied.

### SUMMARY OF PARTICULAR EMBODIMENTS

One of the problems with existing search methods is that when a search query (e.g., a text string) is received, it may be technically challenging to determine which entities are being referenced in the search query. For example, if a user searches for “Donald”, the search engine may determine that this term is ambiguous and unable to resolve whether the user is intending to find content relating to “Donald Trump”, “Donald Duck” (both of which are popular entities), or some other entity named “Donald” (e.g., friends of the querying user named “Donald”). In particular embodiments, the social-networking system may improve the parsing of search queries in order to more accurately detect references to entities in the search queries by using metadata associated with the n-grams in the search query. This metadata may be pre-generated and retrieved from a mining-search-log database. This metadata may be mined offline based on previous user search queries and their interactions relating to these queries. For example, in response to search queries from users over a particular time window (e.g., last two weeks, thirty days, ninety days, six months, one year, etc.), the social-networking system may record content objects (e.g., posts, news articles, images, videos, advertisements, links, etc.) interacted with (e.g., viewed, clicked, etc.) by users corresponding to the search queries as metadata in the mining-search-log database. In particular embodiments, the metadata may include, for each n-gram of a search query, the top N entity identifiers (IDs) along with their click-through rates (CTR) information and the top K co-occurring n-grams associated with the n-gram. The CTR information for an entity ID may indicate how many times did querying users interacted with content objects relating to the entity corresponding to that entity ID in response to a search query. For example, for the n-gram “Donald”, the metadata may include two top entity identifiers: ID 0001 having a name string “Donald Trump” with a CTR of 90%, and ID 0005 having a name string “Donald Duck” with a CTR of 10%. That is, when people searched for “Donald”, 90% of the time they clicked, viewed, interacted with content (e.g., posts, photos, videos, etc.) relating to the entity “Donald Trump”, and the remaining 10% of the time they clicked on content relating to “Donald Duck”. By using this metadata, the social-networking system, when processing a search query (e.g., search query “Donald”), would be able to determine that the entity most likely referenced here is “Donald Trump,” and hence may link the query to the entity ID 0001 (e.g., map the query as being related to “Donald Trump” or determine that user search or query is regarding “Donald Trump”) to improve the quality of retrieved content (e.g., by upranking posts tagging this entity).

The embodiments disclosed herein may provide the social-networking system with a technical solution to the problem of parsing ambiguous queries described above by improving the detection of entities in search queries, improving the identification of content matching the intent of a search query, and/or improving the ranking of search results by presenting, for example, the most relevant, comprehensive, and/or popular results in response to a user's search query. The technical solution to the problem discussed herein helps in computer processing by improving query processing time since the system may quickly detect one or more entities that the query is about based on pre-generated metadata discussed herein and identify search results specific to these detected entities. This further reduces overall computational load on the system or saves processing power since query may be processed much faster and without requiring much computational resources at real-time since the metadata based on which the query is processed is pre-generated and mined offline at a previous time in the mining-search-log database. Also, apart from quickly detecting the entities in search queries, the system may provide improved search results by providing content containing particular co-occurring n-grams associated with these search queries based on metadata retrieved from the mining-search-log database. These improved search results may decrease the number of additional searches performed by the user to identify the desired search results and therefore, the embodiments disclosed herein may have another technical advantage of limiting the bandwidth used between a user and a social-networking system. Besides the metadata being used for detecting search entities, identifying matching content, and/or ranking search results, the metadata may be also used in other applications including query rewriting, query suggestions (e.g., for a typeahead process), or other suitable applications. Although this disclosure describes improving the detection of search entities, retrieval of content, and/or quality of search results based on metadata retrieved from a mining-search-log database in a particular manner, this disclosure contemplates improving the detection of search entities, retrieval of content, and/or quality of search results based on metadata from the mining-search-log-database in any suitable manner.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3 illustrates an example partitioning for storing objects of a social-networking system.

FIG. 4 illustrates an example of a mining-search-log database containing example metadata.

FIG. 5 illustrates an example of metadata that may be retrieved from the mining-search-log database for an example search query.

FIG. 6 illustrates an example of entity identification for a user search query based on metadata retrieved from the mining-search-log database.

FIG. 7 illustrates an example of query suggestions based on metadata retrieved from the mining-search-log database.

FIG. 8 illustrates an example method for identifying and ranking search results for a search query based metadata retrieved from the mining-search-log database.

FIG. 9 illustrates an example computer system.

### DESCRIPTION OF EXAMPLE EMBODIMENTS

### System Overview

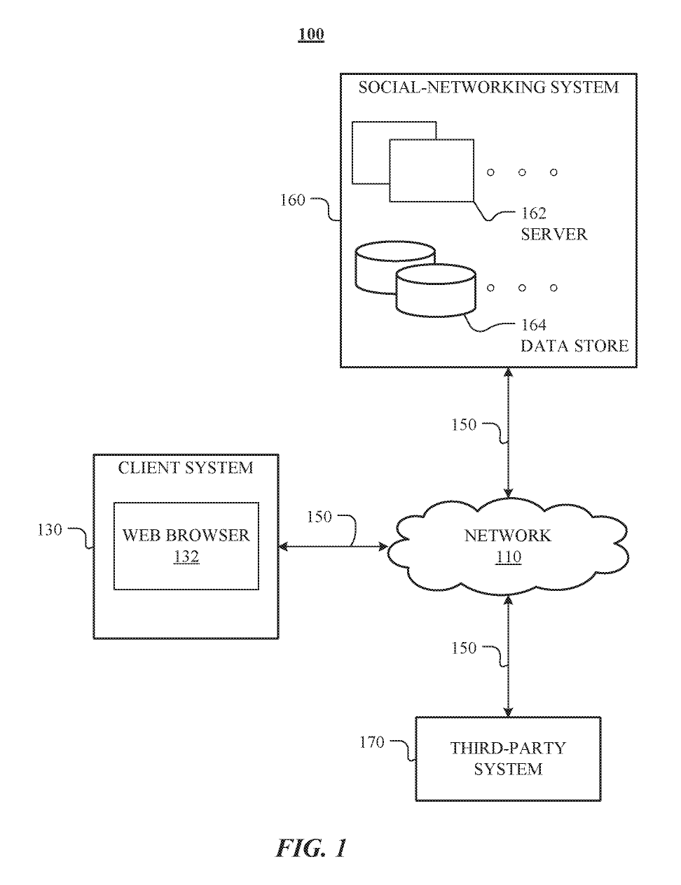

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of a client system 130, a social-networking system 160, a third-party system 170, and a network 110, this disclosure contemplates any suitable arrangement of a client system 130, a social-networking system 160, a third-party system 170, and a network 110. As an example and not by way of limitation, two or more of a client system 130, a social-networking system 160, and a third-party system 170 may be connected to each other directly, bypassing a network 110. As another example, two or more of a client system 130, a social-networking system 160, and a third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client systems 130, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 110 may include one or more networks 110.

Links 150 may connect a client system 130, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be an electronic device including hardware, software, or embedded logic components or a combination of two or more such components and capable of carrying out the appropriate functionalities implemented or supported by a client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at a client system 130 to access a network 110. A client system 130 may enable its user to communicate with other users at other client systems 130.

In particular embodiments, a client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 160 may be a network-addressable computing system that can host an online social network. The social-networking system 160 may generate, store, receive, and send social-networking data, such as, for example, user-profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using a web browser 132, or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a request received from a client system 130. Authorization servers may be used to enforce one or more privacy settings of the users of the social-networking system 160. A privacy setting of a user determines how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Social Graphs

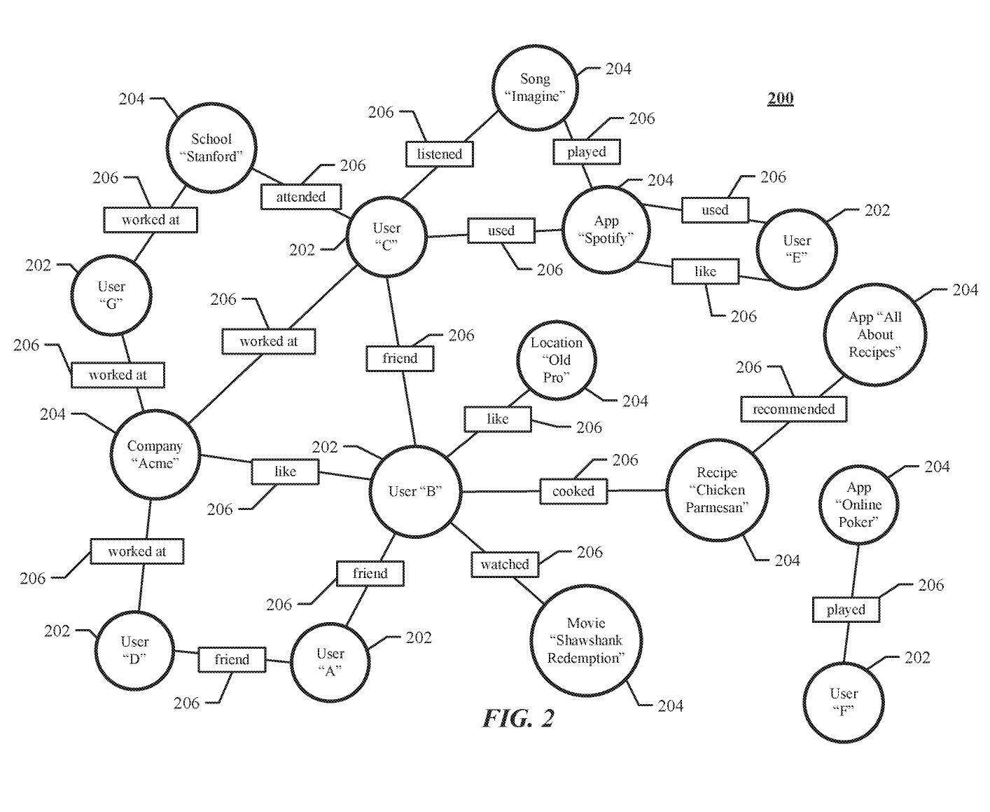

FIG. 2 illustrates an example social graph 200. In particular embodiments, the social-networking system 160 may store one or more social graphs 200 in one or more data stores. In particular embodiments, the social graph 200 may include multiple nodes—which may include multiple user nodes 202 or multiple concept nodes 204—and multiple edges 206 connecting the nodes. The example social graph 200 illustrated in FIG. 2 is shown, for didactic purposes, in a two-dimensional visual map representation. In particular embodiments, a social-networking system 160, a client system 130, or a third-party system 170 may access the social graph 200 and related social-graph information for suitable applications. The nodes and edges of the social graph 200 may be stored as data objects, for example, in a data store (such as a social-graph database). Such a data store may include one or more searchable or queryable indexes of nodes or edges of the social graph 200.

In particular embodiments, a user node 202 may correspond to a user of the social-networking system 160. As an example and not by way of limitation, a user may be an individual (human user), an entity (e.g., an enterprise, business, or third-party application), or a group (e.g., of individuals or entities) that interacts or communicates with or over the social-networking system 160. In particular embodiments, when a user registers for an account with the social-networking system 160, the social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with the social-networking system 160. In particular embodiments, a user node 202 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more web interfaces.

In particular embodiments, a concept node 204 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including the social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more web interfaces.

In particular embodiments, a node in the social graph 200 may represent or be represented by a web interface (which may be referred to as a “profile interface”). Profile interfaces may be hosted by or accessible to the social-networking system 160. Profile interfaces may also be hosted on third-party websites associated with a third-party system 170. As an example and not by way of limitation, a profile interface corresponding to a particular external web interface may be the particular external web interface and the profile interface may correspond to a particular concept node 204. Profile interfaces may be viewable by all or a selected subset of other users. As an example and not by way of limitation, a user node 202 may have a corresponding user-profile interface in which the corresponding user may add content, make declarations, or otherwise express himself or herself. As another example and not by way of limitation, a concept node 204 may have a corresponding concept-profile interface in which one or more users may add content, make declarations, or express themselves, particularly in relation to the concept corresponding to concept node 204.

In particular embodiments, a concept node 204 may represent a third-party web interface or resource hosted by a third-party system 170. The third-party web interface or resource may include, among other elements, content, a selectable or other icon, or other inter-actable object (which may be implemented, for example, in JavaScript, AJAX, or PHP codes) representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing a client system 130 to send to the social-networking system 160 a message indicating the user's action. In response to the message, the social-networking system 160 may create an edge (e.g., a check-in-type edge) between a user node 202 corresponding to the user and a concept node 204 corresponding to the third-party web interface or resource and store edge 206 in one or more data stores.

In particular embodiments, a pair of nodes in the social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 206 connecting the first user's user node 202 to the second user's user node 202 in the social graph 200 and store edge 206 as social-graph information in one or more of data stores 164. In the example of FIG. 2, the social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), sub scriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to an edge type or subtype. A concept-profile interface corresponding to a concept node 204 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, the social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, the social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, the social-networking system 160 may create an edge 206 between a user node 202 and a concept node 204 in the social graph 200. As an example and not by way of limitation, a user viewing a concept-profile interface (such as, for example, by using a web browser or a special-purpose application hosted by the user's client system 130) may indicate that he or she likes the concept represented by the concept node 204 by clicking or selecting a “Like” icon, which may cause the user's client system 130 to send to the social-networking system 160 a message indicating the user's liking of the concept associated with the concept-profile interface. In response to the message, the social-networking system 160 may create an edge 206 between user node 202 associated with the user and concept node 204, as illustrated by “like” edge 206 between the user and concept node 204. In particular embodiments, the social-networking system 160 may store an edge 206 in one or more data stores. In particular embodiments, an edge 206 may be automatically formed by the social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

### Search Queries on Online Social Networks

In particular embodiments, the social-networking system 160 may receive, from a client system of a user of an online social network, a query inputted by the user. The user may submit the query to the social-networking system 160 by, for example, selecting a query input or inputting text into query field. A user of an online social network may search for information relating to a specific subject matter (e.g., users, concepts, external content or resource) by providing a short phrase describing the subject matter, often referred to as a “search query,” to a search engine. The query may be an unstructured text query and may comprise one or more text strings (which may include one or more n-grams). In general, a user may input any character string into a query field to search for content on the social-networking system 160 that matches the text query. The social-networking system 160 may then search a data store 164 (or, in particular, a social-graph database) to identify content matching the query. The search engine may conduct a search based on the query phrase using various search algorithms and generate search results that identify resources or content (e.g., user-profile interfaces, content-profile interfaces, or external resources) that are most likely to be related to the search query. To conduct a search, a user may input or send a search query to the search engine. In response, the search engine may identify one or more resources that are likely to be related to the search query, each of which may individually be referred to as a “search result,” or collectively be referred to as the “search results” corresponding to the search query. The identified content may include, for example, social-graph elements (i.e., user nodes 202, concept nodes 204, edges 206), profile interfaces, external web interfaces, or any combination thereof. The social-networking system 160 may then generate a search-results interface with search results corresponding to the identified content and send the search-results interface to the user. The search results may be presented to the user, often in the form of a list of links on the search-results interface, each link being associated with a different interface that contains some of the identified resources or content. In particular embodiments, each link in the search results may be in the form of a Uniform Resource Locator (URL) that specifies where the corresponding interface is located and the mechanism for retrieving it. The social-networking system 160 may then send the search-results interface to the web browser 132 on the user's client system 130. The user may then click on the URL links or otherwise select the content from the search-results interface to access the content from the social-networking system 160 or from an external system (such as, for example, a third-party system 170), as appropriate. The resources may be ranked and presented to the user according to their relative degrees of relevance to the search query. The search results may also be ranked and presented to the user according to their relative degree of relevance to the user. In other words, the search results may be personalized for the querying user based on, for example, social-graph information, user information, search or browsing history of the user, or other suitable information related to the user. In particular embodiments, ranking of the resources may be determined by a ranking algorithm implemented by the search engine. As an example and not by way of limitation, resources that are more relevant to the search query or to the user may be ranked higher than the resources that are less relevant to the search query or the user. In particular embodiments, the search engine may limit its search to resources and content on the online social network. However, in particular embodiments, the search engine may also search for resources or contents on other sources, such as a third-party system 170, the internet or World Wide Web, or other suitable sources. Although this disclosure describes querying the social-networking system 160 in a particular manner, this disclosure contemplates querying the social-networking system 160 in any suitable manner.

Typeahead Processes and Queries

In particular embodiments, one or more client-side and/or backend (server-side) processes may implement and utilize a “typeahead” feature that may automatically attempt to match social-graph elements (e.g., user nodes 202, concept nodes 204, or edges 206) to information currently being entered by a user in an input form rendered in conjunction with a requested interface (such as, for example, a user-profile interface, a concept-profile interface, a search-results interface, a user interface/view state of a native application associated with the online social network, or another suitable interface of the online social network), which may be hosted by or accessible in the social-networking system 160. In particular embodiments, as a user is entering text to make a declaration, the typeahead feature may attempt to match the string of textual characters being entered in the declaration to strings of characters (e.g., names, descriptions) corresponding to users, concepts, or edges and their corresponding elements in the social graph 200. In particular embodiments, when a match is found, the typeahead feature may automatically populate the form with a reference to the social-graph element (such as, for example, the node name/type, node ID, edge name/type, edge ID, or another suitable reference or identifier) of the existing social-graph element. In particular embodiments, as the user enters characters into a form box, the typeahead process may read the string of entered textual characters. As each keystroke is made, the frontend-typeahead process may send the entered character string as a request (or call) to the backend-typeahead process executing within the social-networking system 160. In particular embodiments, the typeahead process may use one or more matching algorithms to attempt to identify matching social-graph elements. In particular embodiments, when a match or matches are found, the typeahead process may send a response to the user's client system 130 that may include, for example, the names (name strings) or descriptions of the matching social-graph elements as well as, potentially, other metadata associated with the matching social-graph elements. As an example and not by way of limitation, if a user enters the characters “pok” into a query field, the typeahead process may display a drop-down menu that displays names of matching existing profile interfaces and respective user nodes 202 or concept nodes 204, such as a profile interface named or devoted to “poker” or “pokemon,” which the user can then click on or otherwise select thereby confirming the desire to declare the matched user or concept name corresponding to the selected node.

More information on typeahead processes may be found in U.S. patent application Ser. No. 12/763,162, filed 19 Apr. 2010, and U.S. patent application Ser. No. 13/556,072, filed 23 Jul. 2012, which are incorporated by reference.

In particular embodiments, the typeahead processes described herein may be applied to search queries entered by a user. As an example and not by way of limitation, as a user enters text characters into a query field, a typeahead process may attempt to identify one or more user nodes 202, concept nodes 204, or edges 206 that match the string of characters entered into the query field as the user is entering the characters. As the typeahead process receives requests or calls including a string or n-gram from the text query, the typeahead process may perform or cause to be performed a search to identify existing social-graph elements (i.e., user nodes 202, concept nodes 204, edges 206) having respective names, types, categories, or other identifiers matching the entered text. The typeahead process may use one or more matching algorithms to attempt to identify matching nodes or edges. When a match or matches are found, the typeahead process may send a response to the user's client system 130 that may include, for example, the names (name strings) of the matching nodes as well as, potentially, other metadata associated with the matching nodes. The typeahead process may then display a drop-down menu that displays names of matching existing profile interfaces and respective user nodes 202 or concept nodes 204, and displays names of matching edges 206 that may connect to the matching user nodes 202 or concept nodes 204, which the user can then click on or otherwise select thereby confirming the desire to search for the matched user or concept name corresponding to the selected node, or to search for users or concepts connected to the matched users or concepts by the matching edges. Alternatively, the typeahead process may simply auto-populate the form with the name or other identifier of the top-ranked match rather than display a drop-down menu. The user may then confirm the auto-populated declaration simply by keying “enter” on a keyboard or by clicking on the auto-populated declaration. Upon user confirmation of the matching nodes and edges, the typeahead process may send a request that informs the social-networking system 160 of the user's confirmation of a query containing the matching social-graph elements. In response to the request sent, the social-networking system 160 may automatically (or alternately based on an instruction in the request) call or otherwise search a social-graph database for the matching social-graph elements, or for social-graph elements connected to the matching social-graph elements as appropriate. Although this disclosure describes applying the typeahead processes to search queries in a particular manner, this disclosure contemplates applying the typeahead processes to search queries in any suitable manner.

In connection with search queries and search results, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, and U.S. patent application Ser. No. 12/978,265, filed 23 Dec. 2010, which are incorporated by reference.

Structured Search Queries

In particular embodiments, in response to a text query received from a first user (i.e., the querying user), the social-networking system 160 may parse the text query and identify portions of the text query that correspond to particular social-graph elements. However, in some cases a query may include one or more terms that are ambiguous, where an ambiguous term is a term that may possibly correspond to multiple social-graph elements. To parse the ambiguous term, the social-networking system 160 may access a social graph 200 and then parse the text query to identify the social-graph elements that corresponded to ambiguous n-grams from the text query. The social-networking system 160 may then generate a set of structured queries, where each structured query corresponds to one of the possible matching social-graph elements. These structured queries may be based on strings generated by a grammar model, such that they are rendered in a natural-language syntax with references to the relevant social-graph elements. As an example and not by way of limitation, in response to the text query, “show me friends of my girlfriend,” the social-networking system 160 may generate a structured query “Friends of Stephanie,” where “Friends” and “Stephanie” in the structured query are references corresponding to particular social-graph elements. The reference to “Stephanie” would correspond to a particular user node 202 (where the social-networking system 160 has parsed the n-gram “my girlfriend” to correspond with a user node 202 for the user “Stephanie”), while the reference to “Friends” would correspond to friend-type edges 206 connecting that user node 202 to other user nodes 202 (i.e., edges 206 connecting to “Stephanie's” first-degree friends). When executing this structured query, the social-networking system 160 may identify one or more user nodes 202 connected by friend-type edges 206 to the user node 202 corresponding to “Stephanie”. As another example and not by way of limitation, in response to the text query, “friends who work at facebook,” the social-networking system 160 may generate a structured query “My friends who work at Facebook,” where “my friends,” “work at,” and “Facebook” in the structured query are references corresponding to particular social-graph elements as described previously (i.e., a friend-type edge 206, a work-at-type edge 206, and concept node 204 corresponding to the company “Facebook”). By providing suggested structured queries in response to a user's text query, the social-networking system 160 may provide a powerful way for users of the online social network to search for elements represented in the social graph 200 based on their social-graph attributes and their relation to various social-graph elements. Structured queries may allow a querying user to search for content that is connected to particular users or concepts in the social graph 200 by particular edge-types. The structured queries may be sent to the first user and displayed in a drop-down menu (via, for example, a client-side typeahead process), where the first user can then select an appropriate query to search for the desired content. Some of the advantages of using the structured queries described herein include finding users of the online social network based upon limited information, bringing together virtual indexes of content from the online social network based on the relation of that content to various social-graph elements, or finding content related to you and/or your friends. Although this disclosure describes generating particular structured queries in a particular manner, this disclosure contemplates generating any suitable structured queries in any suitable manner.

More information on element detection and parsing queries may be found in U.S. patent application Ser. No. 13/556,072, filed 23 Jul. 2012, U.S. patent application Ser. No. 13/731,866, filed 31 Dec. 2012, and U.S. patent application Ser. No. 13/732,101, filed 31 Dec. 2012, each of which is incorporated by reference. More information on structured search queries and grammar models may be found in U.S. patent application Ser. No. 13/556,072, filed 23 Jul. 2012, U.S. patent application Ser. No. 13/674,695, filed 12 Nov. 2012, and U.S. patent application Ser. No. 13/731,866, filed 31 Dec. 2012, each of which is incorporated by reference.

Generating Keywords and Keyword Queries

In particular embodiments, the social-networking system 160 may provide customized keyword completion suggestions to a querying user as the user is inputting a text string into a query field. Keyword completion suggestions may be provided to the user in a non-structured format. In order to generate a keyword completion suggestion, the social-networking system 160 may access multiple sources within the social-networking system 160 to generate keyword completion suggestions, score the keyword completion suggestions from the multiple sources, and then return the keyword completion suggestions to the user. As an example and not by way of limitation, if a user types the query “friends stan,” then the social-networking system 160 may suggest, for example, “friends stanford,” “friends stanford university,” “friends stanley,” “friends stanley cooper,” “friends stanley kubrick,” “friends stanley cup,” and “friends stanlonski.” In this example, the social-networking system 160 is suggesting the keywords which are modifications of the ambiguous n-gram “stan,” where the suggestions may be generated from a variety of keyword generators. The social-networking system 160 may have selected the keyword completion suggestions because the user is connected in some way to the suggestions. As an example and not by way of limitation, the querying user may be connected within the social graph 200 to the concept node 204 corresponding to Stanford University, for example by like- or attended-type edges 206. The querying user may also have a friend named Stanley Cooper. Although this disclosure describes generating keyword completion suggestions in a particular manner, this disclosure contemplates generating keyword completion suggestions in any suitable manner.

More information on keyword queries may be found in U.S. patent application Ser. No. 14/244,748, filed 3 Apr. 2014, U.S. patent application Ser. No. 14/470,607, filed 27 Aug. 2014, and U.S. patent application Ser. No. 14/561,418, filed 5 Dec. 2014, each of which is incorporated by reference.

### Indexing Based on Object-Type

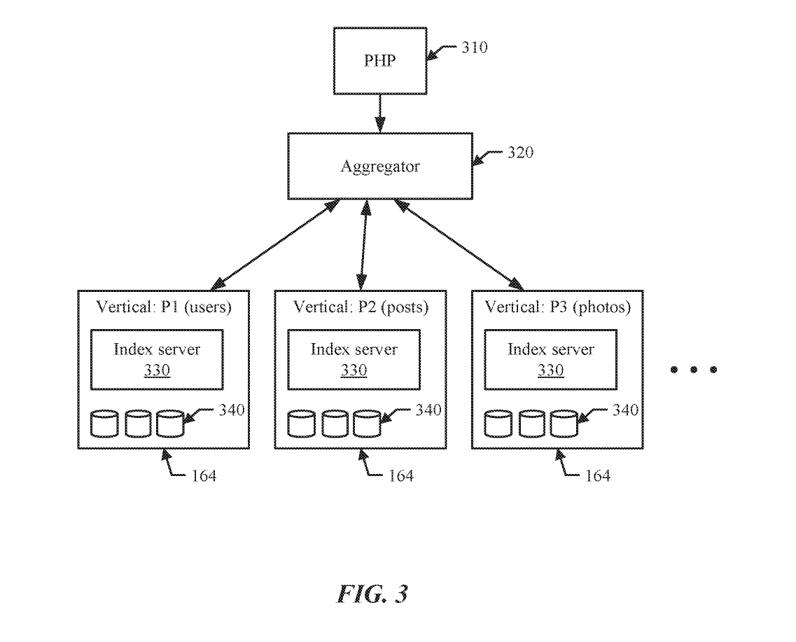

FIG. 3 illustrates an example partitioning for storing objects of a social-networking system 160. A plurality of data stores 164 (which may also be called “verticals”) may store objects of social-networking system 160. The amount of data (e.g., data for a social graph 200) stored in the data stores may be very large. As an example and not by way of limitation, a social graph used by Facebook, Inc. of Menlo Park, Calif. can have a number of nodes in the order of 10⁸, and a number of edges in the order of 10¹⁰. Typically, a large collection of data such as a large database may be divided into a number of partitions. As the index for each partition of a database is smaller than the index for the overall database, the partitioning may improve performance in accessing the database. As the partitions may be distributed over a large number of servers, the partitioning may also improve performance and reliability in accessing the database. Ordinarily, a database may be partitioned by storing rows (or columns) of the database separately. In particular embodiments, a database maybe partitioned based on object-types. Data objects may be stored in a plurality of partitions, each partition holding data objects of a single object-type. In particular embodiments, social-networking system 160 may retrieve search results in response to a search query by submitting the search query to a particular partition storing objects of the same object-type as the search query's expected results. Although this disclosure describes storing objects in a particular manner, this disclosure contemplates storing objects in any suitable manner.

In particular embodiments, each object may correspond to a particular node of a social graph 200. An edge 206 connecting the particular node and another node may indicate a relationship between objects corresponding to these nodes. In addition to storing objects, a particular data store may also store social-graph information relating to the object. Alternatively, social-graph information about particular objects may be stored in a different data store from the objects. Social-networking system 160 may update the search index of the data store based on newly received objects, and relationships associated with the received objects.

In particular embodiments, each data store 164 may be configured to store objects of a particular one of a plurality of object-types in respective data storage devices 340. An object-type may be, for example, a user, a photo, a post, a comment, a message, an event listing, a web interface, an application, a location, a user-profile interface, a concept-profile interface, a user group, an audio file, a video, an offer/coupon, or another suitable type of object. Although this disclosure describes particular types of objects, this disclosure contemplates any suitable types of objects. As an example and not by way of limitation, a user vertical P1 illustrated in FIG. 3 may store user objects. Each user object stored in the user vertical P1 may comprise an identifier (e.g., a character string), a user name, and a profile picture for a user of the online social network. Social-networking system 160 may also store in the user vertical P1 information associated with a user object such as language, location, education, contact information, interests, relationship status, a list of friends/contacts, a list of family members, privacy settings, and so on. As an example and not by way of limitation, a post vertical P2 illustrated in FIG. 3 may store post objects. Each post object stored in the post vertical P2 may comprise an identifier, a text string for a post posted to social-networking system 160. Social-networking system 160 may also store in the post vertical P2 information associated with a post object such as a time stamp, an author, privacy settings, users who like the post, a count of likes, comments, a count of comments, location, and so on. As an example and not by way of limitation, a photo vertical P3 may store photo objects (or objects of other media types such as video or audio). Each photo object stored in the photo vertical P3 may comprise an identifier and a photo. Social-networking system 160 may also store in the photo vertical P3 information associated with a photo object such as a time stamp, an author, privacy settings, users who are tagged in the photo, users who like the photo, comments, and so on. In particular embodiments, each data store may also be configured to store information associated with each stored object in data storage devices 340.

In particular embodiments, objects stored in each vertical 164 may be indexed by one or more search indices. The search indices may be hosted by respective index server 330 comprising one or more computing devices (e.g., servers). The index server 330 may update the search indices based on data (e.g., a photo and information associated with a photo) submitted to social-networking system 160 by users or other processes of social-networking system 160 (or a third-party system). The index server 330 may also update the search indices periodically (e.g., every 24 hours). The index server 330 may receive a query comprising a search term, and access and retrieve search results from one or more search indices corresponding to the search term. In some embodiments, a vertical corresponding to a particular object-type may comprise a plurality of physical or logical partitions, each comprising respective search indices.

In particular embodiments, social-networking system 160 may receive a search query from a PHP (Hypertext Preprocessor) process 310. The PHP process 310 may comprise one or more computing processes hosted by one or more servers 162 of social-networking system 160. The search query may be a text string or a search query submitted to the PHP process by a user or another process of social-networking system 160 (or third-party system 170). In particular embodiments, an aggregator 320 may be configured to receive the search query from PHP process 310 and distribute the search query to each vertical. The aggregator may comprise one or more computing processes (or programs) hosted by one or more computing devices (e.g. servers) of the social-networking system 160. Particular embodiments may maintain the plurality of verticals 164 as illustrated in FIG. 3. Each of the verticals 164 may be configured to store a single type of object indexed by a search index as described earlier. In particular embodiments, the aggregator 320 may receive a search request. For example, the aggregator 320 may receive a search request from a PHP (Hypertext Preprocessor) process 210 illustrated in FIG. 2. In particular embodiments, the search request may comprise a text string. The search request may be a structured or substantially unstructured text string submitted by a user via a PHP process. The search request may also be structured or a substantially unstructured text string received from another process of the social-networking system. In particular embodiments, the aggregator 320 may determine one or more search queries based on the received search request. In particular embodiments, each of the search queries may have a single object type for its expected results (i.e., a single result-type). In particular embodiments, the aggregator 320 may, for each of the search queries, access and retrieve search query results from at least one of the verticals 164, wherein the at least one vertical 164 is configured to store objects of the object type of the search query (i.e., the result-type of the search query). In particular embodiments, the aggregator 320 may aggregate search query results of the respective search queries. For example, the aggregator 320 may submit a search query to a particular vertical and access index server 330 of the vertical, causing index server 330 to return results for the search query.

More information on indexes and search queries may be found in U.S. patent application Ser. No. 13/560,212, filed 27 Jul. 2012, U.S. patent application Ser. No. 13/560,901, filed 27 Jul. 2012, U.S. patent application Ser. No. 13/723,861, filed 21 Dec. 2012, and U.S. patent application Ser. No. 13/870,113, filed 25 Apr. 2013, each of which is incorporated by reference.

### Mining Search Logs for Query Metadata

One of the problems with existing search methods is that when a search query (e.g., a text string) is received, it may be technically challenging to determine which entities are being referenced in the search query. For example, if a user searches for “Donald”, the search engine may determine that this term is ambiguous and unable to resolve whether the user is intending to find content relating to “Donald Trump”, “Donald Duck” (both of which are popular entities), or some other entity named “Donald” (e.g., friends of the querying user named “Donald”). In particular embodiments, the social-networking system 160 may improve the parsing of search queries in order to more accurately detect references to entities in the search queries by using metadata associated with the n-grams in the search query. This metadata may be pre-generated and retrieved from a mining-search-log database. This metadata may be mined offline based on previous user search queries and their interactions relating to these queries. For example, in response to search queries from users over a particular time window (e.g., last two weeks, thirty days, ninety days, six months, one year, etc.), the social-networking system 160 may record content objects (e.g., posts, news articles, images, videos, advertisements, links, etc.) interacted with (e.g., viewed, clicked, etc.) by users corresponding to the search queries as metadata in the mining-search-log database. In particular embodiments, the metadata may include for each n-gram of a search query, the top N entity identifiers (IDs) along with their click-through rates (CTR) information and the top K co-occurring n-grams associated with the n-gram. The CTR information for an entity ID may indicate how many times did querying users interacted with content objects relating to the entity corresponding to that entity ID in response to a search query. For example, for the n-gram “Donald”, the metadata may include two top entity identifiers: ID 0001 having a name string “Donald Trump” with a CTR of 90%, and ID 0005 having a name string “Donald Duck” with a CTR of 10%. That is, when people searched for “Donald”, 90% of the time they clicked, viewed, interacted with content (e.g., posts, photos, videos, etc.) relating to the entity “Donald Trump”, and the remaining 10% of the time they clicked on content relating to “Donald Duck”. By using this metadata, the social-networking system 160, when processing a search query (e.g., search query “Donald”), would be able to determine that the entity most likely referenced here is “Donald Trump,” and hence may link the query to the entity ID 0001 (e.g., map the query as being related to “Donald Trump” or determine that user search or query is regarding “Donald Trump”) to improve the quality of retrieved content (e.g., by upranking posts tagging this entity).

The embodiments disclosed herein may provide the social-networking system 160 with a technical solution to the problem of parsing ambiguous queries described above by improving the detection of entities in search queries, improving the identification of content matching the intent of a search query, and/or improving the ranking of search results by presenting, for example, the most relevant, comprehensive, and/or popular results in response to a user's search query. The technical solution to the problem discussed herein helps in computer processing by improving query processing time since the system may quickly detect one or more entities that the query is about based on pre-generated metadata discussed herein and identify search results specific to these detected entities. This further reduces overall computational load on the system or saves processing power since query may be processed much faster and without requiring much computational resources at real-time since the metadata based on which the query is processed is pre-generated and mined offline at a previous time in the mining-search-log database. Also, apart from quickly detecting the entities in search queries, the system may provide improved search results by providing content containing particular co-occurring n-grams associated with these search queries based on metadata retrieved from the mining-search-log database. These improved search results may decrease the number of additional searches performed by the user to identify the desired search results and therefore, the embodiments disclosed herein may have another technical advantage of limiting the bandwidth used between a user and a social-networking system 160. Besides the metadata being used for detecting search entities, identifying matching content, and/or ranking search results, the metadata may be also used in other applications including query rewriting, query suggestions (e.g., for a typeahead process), or other suitable applications. Although this disclosure describes improving the detection of search entities, retrieval of content, and/or quality of search results based on metadata retrieved from a mining-search-log database in a particular manner, this disclosure contemplates improving the detection of search entities, retrieval of content, and/or quality of search results based on metadata from the mining-search-log database in any suitable manner.

In particular embodiments, the social-networking system 160 may generate and store the metadata in the mining-search-log database in the following way. A mining search logs (MSL) service component of the social-networking system 160 may record, from a plurality of client systems 130 associated with a plurality of users of an online social network, a plurality of prior search queries executed on the online social network. Each prior search query may comprise one or more query terms and one or more content objects accessed (e.g., interacted with, viewed, browsed, etc.) by the plurality of users in response to the prior search query. These prior search queries may be queries received over a particular time window (e.g., last two weeks, thirty days, ninety days, six months, one year, etc.). The time window may be a pre-specified period of time prior to a current time and the length of the period may vary depending on the particular embodiment. As an example and not by way of limitation, the time window may be the past one hour, 24 hours, one week, two weeks, one month, or another suitable length of time. It should be understood that a shorter or more recent time window may provide more focused or recently-biased results whereas a longer or less recent time window may provide less focused or more generic results. In particular embodiments, the social-networking system 160 may record user interactions with content objects (accessed in response to prior search queries) based on a plurality of real-time counters and/or batch counters. Each counter may store a number of the type of user interactions the social networking system 160 has recorded for a particular time window. Real-time counters may only record user interactions for a relatively short amount of time or shorter time window (e.g., the past 24 hours) in order to stay relevant. In contrast, batch counters may record user interactions over a longer time window (e.g., the past month), showing the development of historical trends. An engagement score based on real-time and/or batch counters may be associated with each of the content objects. The engagement score may be a weighted combination of values from one or more real-time counters and one or more batch counters associated with a particular content object. The engagement score may be a calculated probability representing how likely a user is to interact with the particular content object based on the recent and historical behavior of a plurality of users with respect to the particular content object. In some embodiments, the engagement score may be used to calculate a click-through rate (CTR) relating to an entity, as discussed later below. Using the engagement scores, the social-networking system 160 may provide content objects with a comparatively high level of recent user interaction and content objects with a comparatively high level of interaction historically in response to various search queries. More information on real-time counters, batch counters, and engagement scores may be found in U.S. patent application Ser. No. 15/611,667, filed on 1 Jun. 2017, which is incorporated herein by reference.

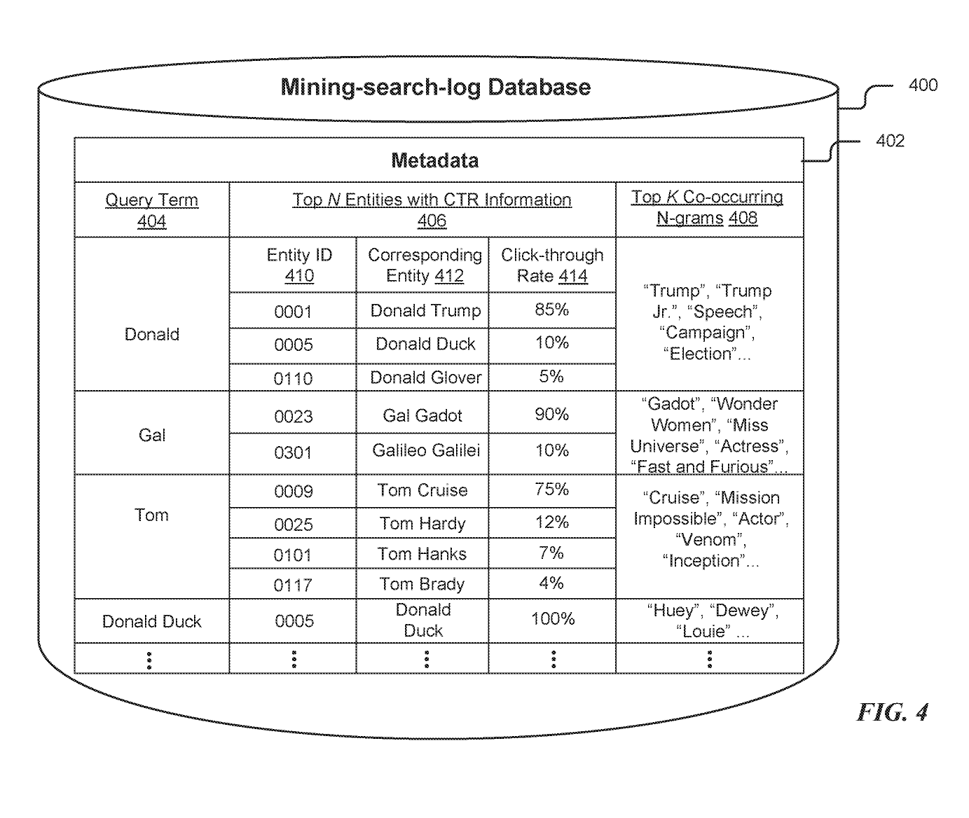

In particular embodiments, based on prior search queries from plurality of users and content objects accessed in response to receiving search results corresponding to the prior search queries, the MSL service component of the social-networking system 160 may generate metadata that may be used for entity identification and/or refinement of search results in response to a future user search query. The metadata that may be generated from a prior search query may include, as an example and not by way of limitation, top-clicked entity IDs and their corresponding entities for which one or more content objects (e.g., profile page, posts, links, images, video clips, audio clips, advertisements, news articles, comments, etc.) relating to each of these entities were interacted with (e.g., viewed by, clicked on, etc.) by users in relation to that query. User interactions with the one or more content objects relating to the entity may be indicated by one or more of the real-time counters or batch counters as discussed above. In particular embodiments, entity IDs may be unique IDs for identifying unique entities associated with the online social network. Entities may include users of the online social network, users tagged in content objects posted on the online social network, authors of content objects on the online social network, public figures, businesses, places, groups, fiction characters, non-fiction characters, etc. It should be noted that any number of entity IDs and their corresponding entities may be included in the metadata for a particular search query. Along with the top-clicked entities, their CTR information may also be recorded for each of the entities. The CTR information for each entity may indicate, for example, the number of times users interacted (e.g., viewed, clicked) with content objects relating to that entity. In some embodiments, the CTR information may be calculated based on engagement scores associated with the content objects, as discussed above. In particular embodiments, the CTR information may be indicated by a percentage value. For example, CTR information for the top-clicked entity IDs 0001, 0005, and 0110 (as shown in FIG. 4 in reference to query term “Donald”) may include 85%, 10%, and 5%, respectively, indicating that when people queried for “Donald”, 85% of the time they clicked, viewed, and/or interacted with content relating to “Donald Trump”, 10% of the time they clicked on content relating to “Donald Duck”, and remaining 5% of the time they clicked on content relating to “Donald Glover”.

In addition to recording top-clicked entities along with their CTR information, the metadata for a particular query term may also include the top K co-occurring n-grams associated with the query term. For instance, the top K co-occurring n-grams may indicate related terms that often show up or appear with the query term. As an example and not by way of limitation, continuing with the user query “Donald” example above, terms like “Trump”, “Wall”, “Virginia”, “Speech”, “Election”, “President”, “Duck”, “Disney”, etc. showed up when people queried for “Donald”. In some embodiments, these top K n-grams terms may be identified using keyword recognition and term frequency-inverse document frequency (TF-IDF) analysis of the associations between search results and search queries (as discussed in U.S. patent application Ser. No. 15/820,966, filed on 22 Nov. 2017, and U.S. patent application Ser. No. 15/821,020, filed on 22 Nov. 2017, each of which is hereby incorporated by reference in its entirety). In particular embodiments, the top K co-occurring n-grams may be chosen based on TF-IDF scores associated with the n-grams. The TF-IDF scores may help to identify terms that appear with higher frequency in a given document as compared to a corpus of documents (e.g., all posts on the online social network posted within a given time window). A TF-IDF score may be assigned to each of the co-occurring n-gram or related term and the social-networking system 160 may choose the top K co-occurring n-grams by selecting n-grams that have TF-IDF scores above a certain threshold score. For example, the social-networking system 160 may choose the top K co-occurring n-grams whose TF-IDF scores are above 0.5, where the TF-IDF scores range within 0 to 1. More information on TF-IDF scores and how they are calculated may be found in U.S. patent application Ser. No. 15/820,966, filed on 22 Nov. 2017, which is incorporated by reference).

FIG. 4 illustrates an example of a mining-search-log database 400 containing example metadata 402. As discussed elsewhere herein, the metadata 402 may be generated and stored in the database 400 based on prior search queries and content objects accessed by a plurality of users in response to these queries over a certain time window. For each of the query terms 404, the metadata 400 may comprise at least (1) the top N entities 406 including, for each entity, an entity ID 410, an entity name 412, and its respective click-through rate 414, and (2) the top K co-occurring n-grams 408 associated with the query term. As an example and not by way of limitation, for the query term “Gal”, the metadata includes two top-clicked entities having entity ID 0023 belonging to entity “Gal Gadot” having a CTR of 90% and entity ID 0301 belonging to entity “Galileo Galilei” having a CTR of 10%. Using this metadata, the social-networking system 160, at time of query processing, may be able to determine that when a user searches for “Gal” or “gal”, the entity referenced in the user query relates to “Gal Gadot” (since in prior search queries relating to this query term, 90% of the time users interacted with content objects relating to this entity) and may provide search results accordingly. Also, the top K co-occurring n-grams associated with this user query, such as “Gadot”, “Wonder Women”, “Miss Universe”, “Actress”, etc. may be used by a typeahead process of the social-networking system 160 for query suggestions (as discussed and shown in reference to at least FIG. 7) or for upranking search results (e.g., by promoting search results containing one or more of these co-occurring n-grams). Although this disclosure shows FIG. 4 as having two particular metadata (e.g., metadata 406 and 408) for each of the query terms, this disclosure contemplates additional metadata information for each query term, as discussed later below in this disclosure. Also, it should be understood that although FIG. 4 shows metadata for four particular query terms stored in the mining-search-log database 400, this is not by any way limiting and metadata for any number of query terms may be stored in the database 400.

Apart from the top N entities and the top K co-occurring n-grams associated with a particular query term, the metadata may also include, in certain instances, a number of page impressions or views (e.g., how many times one or more content objects (e.g., pages, posts, photos, videos, etc.) relating to an entity got clicked or viewed), time sensitivity information (e.g., when one or more content objects relating to an entity got created and/or were viewed/clicked, etc.), location sensitivity information (e.g., geographic region information about content objects or authors that authored the content objects) that may be used for regional filtering, person name classification information (e.g., a calculated probability that the search query is about a user/person based on user interaction with a previous query relating to the search query), and scores associated with pages relating to the search query (e.g., for the search query “John Wu”, there may be a user profile page on John Wu and a page relating to a movie on John Wu. The user profile page may be clicked more than the movie page and so will have a higher score than the other page).

In particular embodiments, the metadata discussed herein may be mined offline in the mining-search-log database in batches (e.g., every one million queries) or at periodic/fixed time intervals. As an example and not by way of limitation, the metadata may be generated or mined every day, every two days, every week, and so on. Because this process may be processor-intensive and relatively slow, mining the metadata offline or pre-generating the metadata is technically advantageous as when a search query is received from a user at a future time, the pre-generated metadata can be used to quickly identify one or more entities that are referenced in the query and generate search results that relates and/or corresponds to these one or more identified entities (e.g., by surfacing content objects relating to identified entities on top for display) as discussed elsewhere herein. Thus, there is a minimal contribution to latency due to the use of this pre-mined metadata when processing a search query, minimizing any additional use of processor resources due to using the metadata. During mining, a specific time window may be considered for selecting prior search queries and processing these search queries to generate the metadata. For example, search queries from last thirty days may be considered to generate the metadata. In some embodiments, a more recent time window may be considered (e.g., past one week, last three days, etc.) in order to generate metadata for content objects relating to entities that may be trending or are popular in that specific time window.

In particular embodiments, apart from batch or offline processing of metadata in the mining-search-log database, a real-time component of the social-networking system 160 may generate metadata in real-time and process a search query based on this real-time generated metadata. For instance, the real-time component of the social-networking system 160 may feed data (e.g., content objects, search queries, etc.) into the mining-search-log database as they come in and use that to generate search results for a search query received at a current time. In some embodiments, the social-networking system 160 may generate metadata in real-time based on one or more real-time counters (discussed above and in further detail in U.S. patent application Ser. No. 15/611,667, filed on 1 Jun. 2017). In some embodiments, the top-clicked entity IDs and their CTR information may not be available in the real-time scenario (e.g., since prior search queries may not be processed and logged in the mining-search-log database). In such a case, other metadata such as, for example, top related terms (e.g., terms that often show up relating to the current search query) based on TF-IDF analysis (as discussed above) may be used to identify top entities and search results corresponding to these entities. As an example and not by way of limitation, if a search query term is “Duck”, then related terms “Donald Duck”, “Donald”, “Huey”, “Dewey”, “Louie”, often show up and these related terms may be used to identify content objects for providing as search results in response to the search query. In particular embodiments, the social-networking system 160 may rank the related terms and content objects corresponding to these related terms based on a TF-IDF score associated with each of these related terms (as discussed in U.S. patent application Ser. No. 15/820,966, filed on 22 Nov. 2017, hereby incorporated by reference).

It should be understood that generating search results for a search query is not limited to being based on metadata from a mining-search-log database. This disclosure contemplates any suitable data sources for generating and/or filtering search results. As an example and not by way of limitation, other data sources such as subscribed content providers (e.g., sports-related content provider, movie-related content provider, etc.), online social media platforms, news channels, podcasts, etc., may be used to identify trending entities and corresponding content objects (e.g., posts, links, photos, videos, etc.) relating to the search query. In some embodiments, data from these other data sources may be stored in the mining-search-log database.

In particular embodiments, the social-networking system 160 may process a search query and generate search results in the following way. The social-networking system 160 may receive, from a client system 130 associated with a first user (also referred to as a “querying user”) of an online social network, a search query comprising a character string. The character string may be, for example, a text string inputted into a query field on user interface of the online social network installed on the client system 130. For example, the querying user may enter a text string “Donald Trump Virginia Speech”. In particular embodiments, the social-networking system 160 may receive the search query from a PHP (Hypertext Preprocessor) process, such as the PHP process 310 (as discussed in reference to FIG. 3). In particular embodiments, a natural language processing (NLP) component of the social-networking system 160 may parse the search query to identify one or more n-grams. The n-grams can be any length n, including unigram, bigram, trigram, and beyond. As an example and not by way of limitation, the NLP component of the social-networking system 160 may parse the text string “Donald Trump Virginia Speech” to identify four unigrams “Donald”, “Trump”, “Virginia”, and “Speech”; three bigrams “Donald Trump”, “Trump Virginia”, and “Virginia Speech”, and two trigrams “Donald Trump Virginia” and “Trump Virginia Speech”. Although this disclosure describes identifying particular n-grams in a particular manner, this disclosure contemplates identifying any suitable n-grams in any suitable manner.

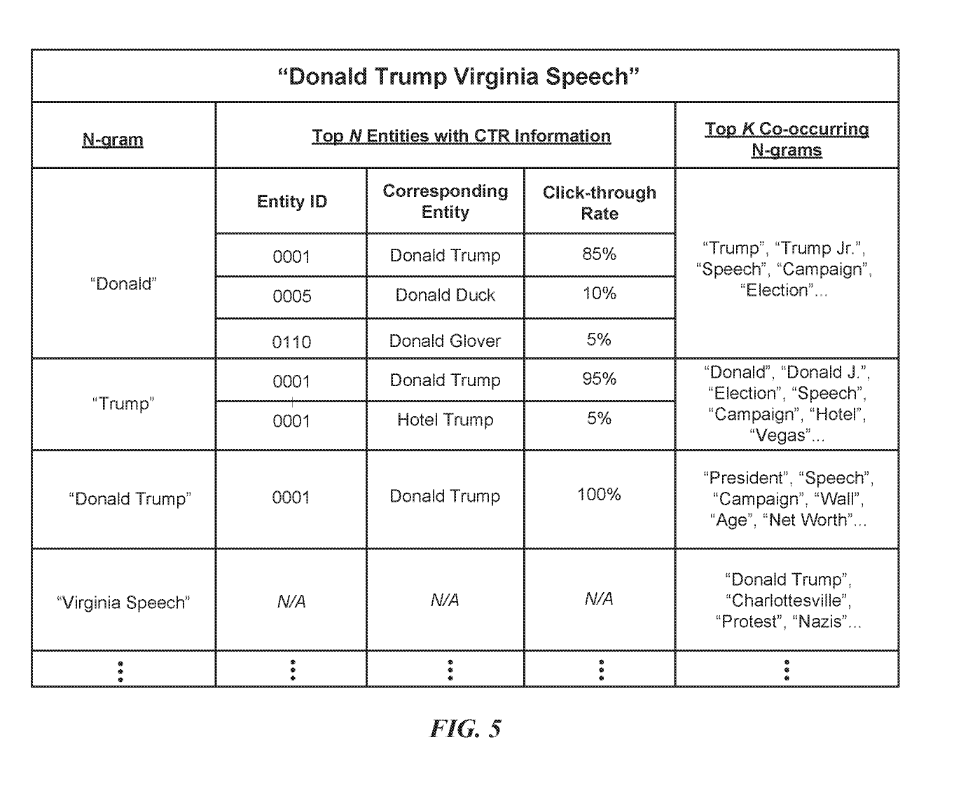

For each identified n-gram, the NLP component of the social-networking system 160 may make a call to the MSL service component, which may be a back-end software service that retrieves metadata relating to the n-gram from the mining-search-log database and returns the metadata for further processing (e.g., entity identification, ranking search results, query rewriting, etc.). In particular embodiments, for each identified n-gram, the MSL service component returns at-least (1) the top N entity identifiers (IDs) corresponding to entities associated with the identified n-gram and their respective click-through rate (CTR) information, and (2) the top K co-occurring n-grams for the identified n-gram, as discussed above and in further detail below in reference to FIG. 5. It should be understood that the retrieved metadata from the mining-search-log database is not limited to the top N entities and the top K co-occurring n-grams for the identified n-gram and may include other metadata such as, for example and without limitation, a number of page impressions or views (e.g., how many times one or more content objects relating to the n-gram got clicked or viewed), time sensitivity information (e.g., when one or more content objects relating to the n-gram got created and/or were viewed/clicked, etc.), location sensitivity information (e.g., geographic region information about content objects or authors that authored the content objects), person name classification information (e.g., a calculated probability that the identified n-gram relates to a user/person), and scores associated with pages relating to the n-gram.

FIG. 5 illustrates an example of metadata that may be retrieved from a mining-search-log database (e.g., the mining-search-log database 400) for an example search query. As depicted, the search query comprises a text string “Donald Trump Virginia Speech”. Although FIG. 5 shows metadata for certain n-grams including unigrams “Donald” and “Trump” and bigrams “Donald Trump” and “Virginia Speech”, it should be understood that metadata for other remaining n-grams, such as “Virginia”, “Speech”, “Trump Virginia”, “Donald Trump Virginia”, and “Trump Virginia Speech”, may be retrieved from the mining-search-log database in a similar manner. As illustrated, the metadata for each n-gram includes at-least the top N entities with their respective CTR information and the top K co-occurring n-grams associated with the n-gram. The top N entities column for each n-gram may comprise an entity ID, entity that the ID corresponds to, and its respective click-through rate. As an example and not by way of limitation, for n-gram “Donald”, the metadata includes three entries {ID 0001 corresponding to Donald Trump having CTR=85%}, {ID 0005 corresponding to Donald Duck having CTR=10%}, and {ID 0110 corresponding to Donald Glover having CTR=5%} indicating that when people searched for term “Donald”, 85% of the time they clicked on content objects (e.g., posts, links, news articles, videos, images, etc.) relating to Donald Trump, 10% on content objects relating to Donald Duck, and only 5% on content objects relating to Donald Glover. In some embodiments, entity and CTR information may not be available for an n-gram. For example, as shown in reference to n-gram “Virginia Speech” in FIG. 5, the n-gram does not belong to a specific entity and hence no entity ID and CTR information is available for this n-gram. However, top co-occurring n-grams that show up with the n-gram “Virginia Speech” during a particular time window may still be included that may help in filtering content objects (e.g., by selecting or upranking posts that contain the co-occurring n-grams).

In particular embodiments, in response to receiving a search query from a client system 130 associated with a querying user, the social-networking system 160 may identify a plurality of content objects matching the search query. In particular embodiments, identifying a plurality of content objects matching the search query may comprise searching a plurality of data stores or verticals using the search query as discussed above in reference to FIG. 3. The content objects may include, for example, one or more of social media posts, video clips, audio clips, images, comments, news articles, advertisements, profile pages of users, etc. Using the metadata retrieved from the mining-search-log database (as shown for example in FIG. 5), the social-networking system 160 may rank the content objects matching the search query based on whether the content objects contain one or more of top N entities or one or more of top K co-occurring n-grams from the metadata retrieved from the mining-search-log database. By way of an example, for a search query “Donald”, the social-networking system 160 may identify some posts relating to Donald Trump, some posts relating to Donald Duck, some posts relating to Donald Glover, and posts relating to one or more other entities. Using the metadata such as the metadata shown in FIG. 5, the social-networking system 160 may assign a rank one to posts relating to Donald Trump (since click-through rate for this entity is the highest), a rank two to posts relating to Donald Duck, a rank three to posts relating to Donald Glover, and subsequent ranks to posts relating to other entities. That is, posts relating to Donald Trump will be showed first followed by posts relating to Donald Duck followed by posts relating to Donald Glover, and so on. In some embodiments, the social-networking system 160 may display content objects only corresponding to the top-clicked entity. For example, the social-networking 160, in response to the search query “Donald”, may display posts regarding “Donald Trump” since this entity is identified as the top entity based on its click-through rate as discussed herein. In this scenario, the social-networking system 160 may link the search query to the entity ID having the highest CTR (e.g., entity ID 0001 having CTR of 85%, as shown in FIG. 4) and use this ID to rewrite the query (e.g., “Donald Trump.ID=0001”). The social-networking system 160 may then send this rewritten query to an index server 330 of the social-networking system 160 to retrieve posts associated with this ID from one or more verticals 340. In particular embodiments, the social-networking system 160 may further assign sub-ranks to posts relating to a particular entity. These sub-ranks may be assigned based on whether the posts contain one or more of the top co-occurring n-grams associated with the search query. For example in reference to FIG. 5, a post relating to Donald Trump containing terms like “Speech”, “Campaign”, “Election” will be ranked higher than a post not containing these terms or containing fewer terms. As another example, a post regarding Donald Trump's Virginia speech will be upranked or showed first for display than a post regarding Donald Trump's wife. Once the content objects matching the search query are ranked, the social-networking system 160 may send, to the client system 130 associated with the querying user, instructions for presenting search results corresponding to the identified content objects in an order based on the ranking of the corresponding content objects.

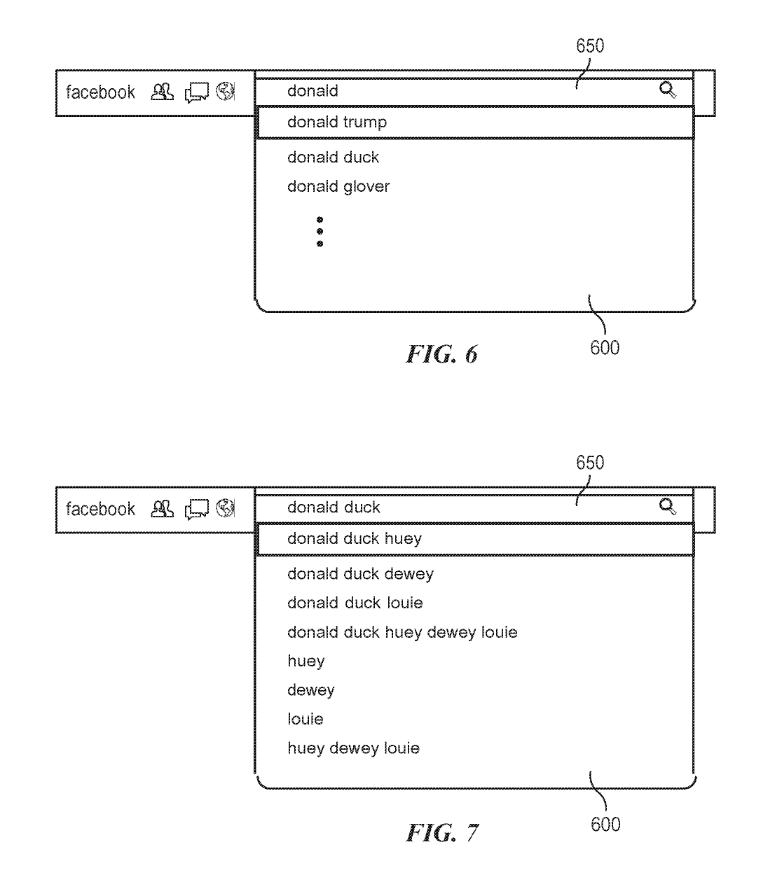

In particular embodiments, the social-networking system 160 may use the metadata retrieved from the mining-search-log database for query rewriting. For instance, the social-networking system 160 may use one or more of the top N entity IDs or one or more of the top K co-occurring n-grams to rewrite a search query. In particular embodiments, rewriting a search query may include displaying query suggestions or one or more suggested queries (e.g., as shown in FIG. 6) or expanding the search query by appending related terms (e.g., terms that often appear with the search query) (e.g., as shown in FIG. 7). In particular embodiments, the one or more suggested queries may be the top-clicked entities retrieved from the mining-search-log database for a given search query term. The one or more suggested queries may be ranked for display based on click-through rates associated with the top-clicked entities. For instance, a suggested query with highest CTR will be given a rank one and hence showed at the top of the display. In some embodiments, the query term may be automatically replaced with a suggested query corresponding to the top-clicked entity (e.g., entity ID having the highest CTR). As an example and not by way of limitation, in a search query “Donald”, the aggregator component 320 of the social-networking system 160 may determine entity ID 0001 (belong to “Donald Trump”) as having the highest CTR (e.g., 90%) among the other IDs and use that ID to rewrite the query (e.g., “Donald Trump.ID=0001”) and send it to an index server 330 of the social-networking system 160 to retrieve search results (e.g., posts, photos, videos, links, etc.) associated with this ID from one or more verticals 340. In some embodiments, the aggregator 320 may add a Boolean expression to prioritize certain search results containing some particular co-occurring n-grams. For example, co-occurring n-grams “Virginia Speech” and “Immigration” associated with the entity ID 0001 (belonging to Donald Trump) may be upranked (e.g., assign rank 1) as compared to other co-occurring n-grams, such as “Campaign,” “Eclipse,” “Election,” etc.

Content objects identified for original search query may match the rewritten search query, and at least a portion of the identified content objects may relate to entities corresponding to top N entity IDs or may comprise one or more top K co-occurring n-grams associated with the search query term. To improve the relevance of identified content objects, the social-networking system 160 may provide one or more suggested queries based on top-clicked entities retrieved from the mining-search-log database in order of their respective CTR (as discussed above) or may append related terms to the search query based on top co-occurring n-grams that are found to be often associated with the search query (as shown for example in FIG. 7), e.g., as a weak AND (WAND) operator. For example, if a user searches for “gal”, the query may be rewritten to require a fraction of the results to also contain one or more of the co-occurring n-grams “gadot”, “wonder women”, “miss universe”, “actress”, etc. More information on rewriting queries may be found in U.S. Pat. No. 9,367,880, issued on 14 Jun. 2016, which is incorporated herein by reference.

FIG. 6 illustrates an example of entity identification for a user search query based on metadata retrieved from a mining-search-log database. As shown in FIG. 6, a query “donald” is entered into the search box 650 and suggested queries “donald trump”, “donald duck”, or “donald glover” may be displayed in the drop-down menu 600. In particular embodiments, the suggested queries may be based on the top N entities retrieved from the mining-search-log database for the respective query term and the order of these suggested queries may be based on click-through rates associated with these top N entities, as shown and discussed in reference to at least FIGS. 4 and 5. For example, suggested query “donald trump” may be displayed first since it has a CTR of 85% followed by suggested query “donald duck” having CTR of 10% and lastly “donald glover” having CTR of only 5%.

FIG. 7 illustrates an example of query suggestions based on metadata retrieved from a mining-search-log database. As shown in FIG. 7, a query “donald duck” is entered into the search box 650 and the typeahead process may append related terms “huey”, “dewey”, or “louie” to the query. As a result, queries including “donald duck huey”, “donald duck dewey”, “donald duck louie”, or “donald duck huey dewey louie” are displayed in the drop-down menu 600. In particular embodiments, these related terms may appear based on top K co-occurring n-grams retrieved from the mining-search-log database for the respective query term “donald duck”, as discussed and shown for example in reference to FIG. 4. In some embodiments, the query rewriting may replace the query with the related terms “huey”, “dewey”, or “louie” and display suggested queries including “huey”, “dewey”, “louie”, or “huey dewey louie” in the drop-down menu 600. Although this disclosure describes providing particular query suggestion in a particular manner, this disclosure contemplates providing any suitable query suggestion in any suitable manner.

It should be understood that query rewriting is not limited to be based on the top N entities and the top K co-occurring n-grams associated with a search query and other metadata discussed herein may also be used to rewrite the search query. As an example and not by way of limitation, using the metadata such as time sensitivity information (e.g., information regarding when one or more content objects got created and/or were viewed/clicked, etc.), search results for a particular time window may be retrieved for the search query. For example, if a user wants search results in last 24 hours or recent results for a particular query, then the aggregator 320 may rewrite the query to indicate this using the time sensitivity information retrieved from the mining-search-log database. Other ways of query rewriting using the metadata are also possible and within the scope of the present disclosure.

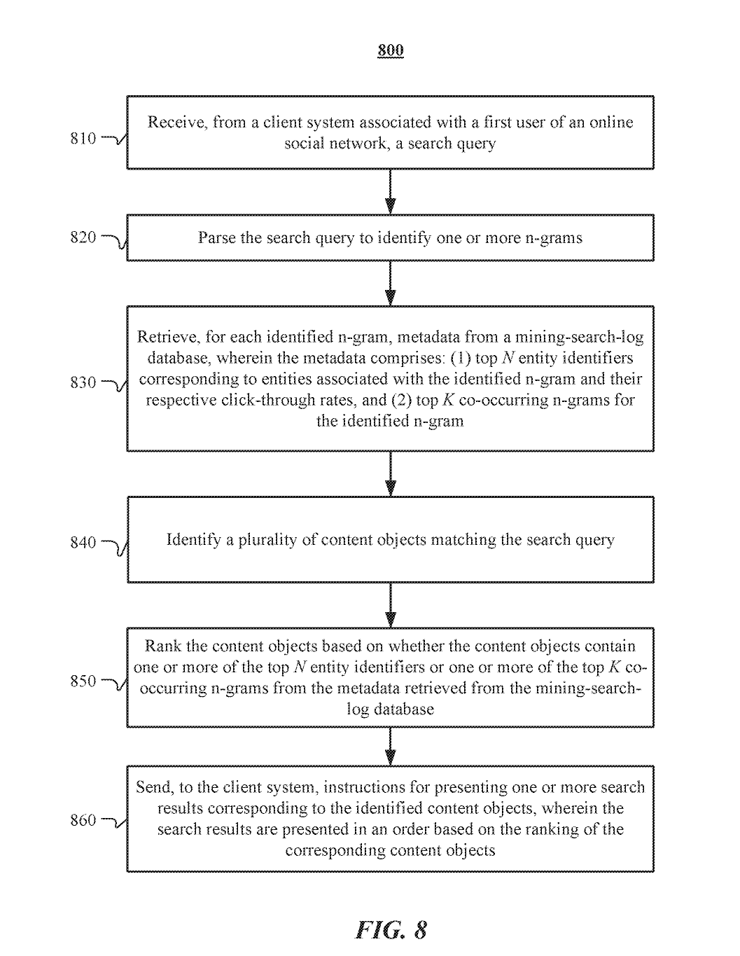

FIG. 8 illustrates an example method 800 for identifying and ranking search results for a search query based on metadata retrieved from a mining-search-log database (e.g., the mining-search-log database 400). The method may begin at step 810, where the social-networking system 160 may receive, from a client system 130 associated with a first user of an online social network, a search query. The search query may include a text string. At step 820, the social-networking system 160 may parse the search query to identify one or more n-grams. At step 830, the social-networking system 160 may retrieve, for each identified n-gram, metadata from a mining-search-log database, wherein the metadata comprises: (1) top N entity identifiers corresponding to entities associated with the identified n-gram and their respective click-through rates, and (2) top K co-occurring n-grams for the identified n-gram. At step 840, the social-networking system 160 may identify a plurality of content objects associated with the online social network that match the search query. At step 850, the social-networking system 160 may rank the identified content objects based on whether the content objects contain one or more of the top N entity identifiers or one or more of the top K co-occurring n-grams from the metadata retrieved from the mining-search-log database. At step 860, the social-networking system 160 may send, to the client system 130, instructions for presenting one or more search results corresponding to the identified content objects, wherein the search results are presented in an order based on the ranking of the corresponding content objects. Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for identifying and ranking search results for a search query based metadata retrieved from a mining-search-log database, including the particular steps of the method of FIG. 8, this disclosure contemplates any suitable method for identifying and ranking search results for a search query based metadata retrieved from a mining-search-log database, including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

### Systems and Methods

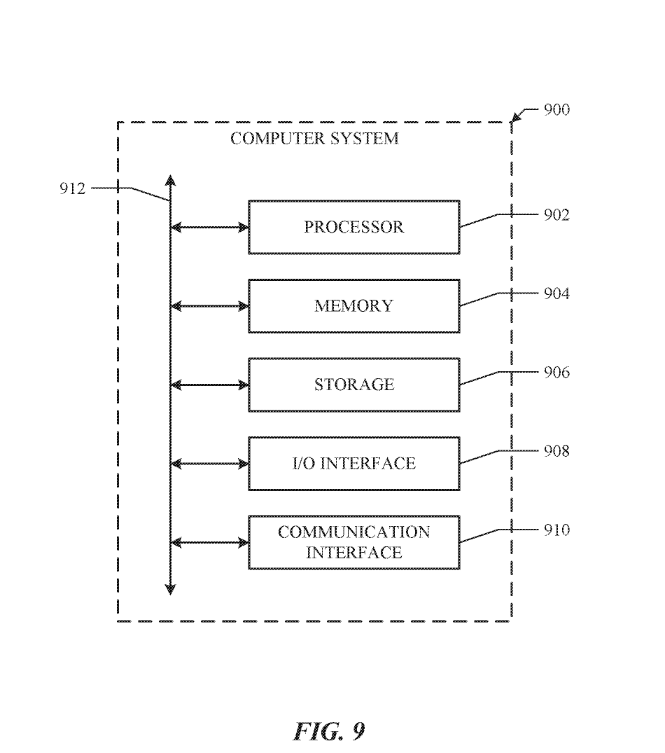

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
receiving, from a client system associated with a first user of an online social network, a search query;
parsing the search query to identify one or more n-grams;
retrieving, for each identified n-gram, metadata from a mining-search-log database, wherein the metadata comprises: (1) top N entity identifiers corresponding to entities associated with the identified n-gram and their respective click-through rates, and (2) top K co-occurring n-grams for the identified n-gram;
identifying a plurality of content objects matching the search query;
ranking the content objects based on whether the content objects contain one or more of the top N entity identifiers or one or more of the top K co-occurring n-grams from the metadata retrieved from the mining-search-log database; and
sending, to the client system, instructions for presenting one or more search results corresponding to the identified content objects, wherein the search results are presented in an order based on the ranking of the corresponding content objects.

2. The method of claim 1, further comprising:
rewriting the search query based on one or more of the top N entity identifiers or one or more of the top K co-occurring n-grams from the metadata retrieved from the mining-search-log database,
wherein the identified content objects match the rewritten search query.

3. The method of claim 1, wherein the search query comprises a text string.

4. The method of claim 3, further comprising:
sending, to the client system responsive to the first user inputting the text string, instructions for displaying one or more suggested queries, wherein at least one of the suggested queries comprises one or more terms related to the search query.

5. The method of claim 4, wherein the one or more terms related to the search query are based on one or more of the top N entity identifiers or one or more of the top K co-occurring n-grams from the metadata retrieved from the mining-search-log database.

6. The method of claim 1, wherein ranking the content objects comprises:
assigning a rank to each of the content objects based on click-through rates for entities associated with one or more of the top N entity identifiers or the top K co-occurring n-grams; and
sorting the content objects based on the ranks assigned to the content objects.

7. The method of claim 6, wherein ranking the content objects further comprises:
if a content object contains one or more of the top N entity identifiers or one or more of the top K co-occurring n-grams, then upranking the content object relative to a content object that does not contain one or more of the top N entity identifiers or one or more of the top K co-occurring n-grams.

8. The method of claim 1, wherein the mining-search-log database comprises a log of prior search queries and content objects accessed responsive to the prior search queries.

9. The method of claim 8, wherein the content objects accessed responsive to the prior search queries comprise content objects that are selected, interacted with, viewed, or browsed by a user in response to receiving search results corresponding to the prior search queries.

10. The method of claim 8, wherein the mining-search-log database stores the log of prior search queries and the content objects for a particular time window.

11. The method of claim 1, wherein the metadata further comprises one or more of:
a number of page impressions or views associated with the identified n-gram;
time sensitivity information indicating time stamps corresponding to the page impressions or views associated with the identified n-gram;
location sensitivity information indicating content objects relating to a particular geographical location referenced in the identified n-gram;
person-name classification information indicating a probability that the identified n-gram relates to a user name based on user interactions with a prior search query relating to the identified n-gram; or
scores for pages on the online social network relating to the identified n-gram, wherein a score for a page is based on its click-through rate.

12. The method of claim 1, the content objects comprise one or more of:
a profile page of a user;
a post;
an audio clip;
a video clip;
a comment;
a news article;
an advertisement; or
a page on the online social network.

13. The method of claim 1, wherein the metadata is mined offline at predetermined time intervals in the mining-search-log database.

14. The method of claim 1, wherein the metadata is mined in real-time in the mining-search-log database.

15. The method of claim 1, wherein the identified one or more n-grams are unigrams or bigrams.

16. The method of claim 1, wherein the entity identifiers are unique identifiers for identifying unique entities associated with the online social network.

17. The method of claim 16, wherein an entity is an author of one or more content objects on the online social network.

18. The method of claim 16, wherein an entity is a user of the online social network or a user tagged in one or more content objects posted on the online social network.

19. One or more computer-readable non-transitory storage media embodying software that is operable when executed to:
receive, from a client system associated with a first user of an online social network, a search query;
parse the search query to identify one or more n-grams;
retrieve, for each identified n-gram, metadata from a mining-search-log database, wherein the metadata comprises: (1) top N entity identifiers corresponding to entities associated with the identified n-gram and their respective click-through rates, and (2) top K co-occurring n-grams for the identified n-gram;
identify a plurality of content objects matching the search query;
rank the content objects based on whether the content objects contain one or more of the top N entity identifiers or one or more of the top K co-occurring n-grams from the metadata retrieved from the mining-search-log database; and
send, to the client system, instructions for presenting one or more search results corresponding to the identified content objects, wherein the search results are presented in an order based on the ranking of the corresponding content objects.

20. A system comprising: one or more processors; and a non-transitory memory coupled to the processors comprising instructions executable by the processors, the processors operable when executing the instructions to:
receive, from a client system associated with a first user of an online social network, a search query;
parse the search query to identify one or more n-grams;
retrieve, for each identified n-gram, metadata from a mining-search-log database, wherein the metadata comprises: (1) top N entity identifiers corresponding to entities associated with the identified n-gram and their respective click-through rates, and (2) top K co-occurring n-grams for the identified n-gram;
identify a plurality of content objects matching the search query;
rank the content objects based on whether the content objects contain one or more of the top N entity identifiers or one or more of the top K co-occurring n-grams from the metadata retrieved from the mining-search-log database; and
send, to the client system, instructions for presenting one or more search results corresponding to the identified content objects, wherein the search results are presented in an order based on the ranking of the corresponding content objects.
